(19) United States
(12) Patent Application Publication
(10) Pub. No.: US 2024/0315298 A1
(43) Pub. Date: Sep. 26, 2024

(54) SIMULTANEOUS HYDROLYSIS OF STARCH AND FLAVOR ENCAPSULATION DURING EXTRUSION

(71) Applicant: Firmenich SA, Satigny (CH)

(72) Inventors: Jian ZHANG, Plainsboro, NJ (US); Ding KANG, Shanghai (CN); Hui Ling GUO, Shanghai (CN); Ai-Quan JIAO, Jiangsu (CN)

(21) Appl. No.: 18/578,053

(22) PCT Filed: Jul. 25, 2022
(86) PCT No.: PCT/EP2022/070759

§ 371 Date: Jan. 10, 2024

Related U.S. Application Data
(60) Provisional application No. 63/203,605, filed on Jul. 27, 2021.

(30) Foreign Application Priority Data
Aug. 3, 2021 (WO) PCT/CN2021/110297
Aug. 19, 2021 (EP) 21192094.7

(51) Int. Cl. A23L 27/00; A23L 27/12; A23L 29/30; A23P 30/25

(52) U.S. Cl. CPC A23L 27/72; A23L 27/13; A23L 29/35; A23P 30/25

(57) ABSTRACT

Described herein is a method for producing an extruded particle including an encapsulated flavor oil, including the steps of providing a raw material composition including starch, water, flavor oil, and an enzyme capable of hydrolyzing starch, and extruding the mixture to form an extruded particle including an encapsulated flavor oil. Also described herein is an extruded particle obtained by the method.

### TECHNICAL FIELD

The present invention relates to a method for producing an extruded particle comprising an encapsulated flavor oil, comprising the steps of providing a raw material composition comprising starch, water, flavor oil, and an enzyme capable of hydrolyzing starch, and extruding the mixture to form an extruded particle comprising an encapsulated flavor oil. The present invention further relates to an extruded particle obtained by the method according to the invention.

### BACKGROUND OF THE INVENTION

The flavor of a consumer product plays an important role in consumer satisfaction.

A common approach to increase the stability of flavor oils, in particular in demanding environments such as in consumer products, is to encapsulate the flavor oils before they are added to a consumer product. This allows to reduce degradation or loss of fragrance compounds during processing and storage.

The encapsulation of flavor oils further allows an on-demand release of the flavor oil in a consumer product and thus prevents an early loss of the flavor oil before the consumer product is actually used by the customer, such as e.g. an early loss of the fragrance impression of the flavor oil.

During the encapsulation process, the flavor oil is entrapped within a carrier material. For the encapsulation of flavor oils, a whole range of carrier materials are known.

Starch and starch-based ingredients (modified starches, maltodextrins, β-cyclodextrins) are widely used in the food industry to retain and protect volatile compounds. In particular, maltodextrins are popular carrier materials for encapsulating flavor oils. Maltodextrins are obtained by partially hydrolyzing starch with acids or enzymes and are supplied as dextrose equivalents (DEs). The DE-value is a measure of the degree of starch polymer hydrolysis. Maltodextrin is a good compromise between cost and effectiveness, as it is tasteless, has a low viscosity at a high solid ratio, and is available in different average molecular weights. Moreover, hydrolyzed starches, such as maltodextrins are often water-soluble, which makes them interesting for many consumer product applications such as powdered beverages.

As indicated above, maltodextrins are produced by the partial hydrolysis of starch, which involves the acid and/or enzymatic hydrolysis of starch in a liquid medium. However, such processes are time-consuming and costly. In particular, a lot of energy is required to remove the water after the hydrolysis step during subsequent evaporation and spray drying steps. Further, once the hydrolysis parameters are set, there is little flexibility as to the type of maltodextrins (characterized by the DE-value) that can be obtained upon the hydrolysis procedure.

Moreover, for encapsulating flavor oils, currently at least two separated method steps are required that are, the production of the maltodextrin in a first step and the subsequent encapsulation step of the flavor oil using maltodextrin as carrier. This renders the encapsulating of flavor oils with maltodextrin as carrier material laborious and costly.

In view of the above, methods are desired that allow a more efficient production of starch hydrolysates, such as maltodextrins, and encapsulation of flavor oils using such carrier materials.

### DETAILED DESCRIPTION OF THE INVENTION

The present invention relates to a method for producing an extruded particle comprising an encapsulated flavor oil, comprising the steps of:
a. providing a raw material composition comprising starch, water, flavor oil, and an enzyme capable of hydrolyzing starch;
b. extruding the mixture provided in step a) to form an extruded particle comprising an encapsulated flavor oil.

The present invention relates to a method for the production of an extruded particle comprising an encapsulated flavor oil, i.e. to a particle that has been obtained by extrusion.

In step a) of the method according to the invention, a raw material composition comprising starch, water, flavor oil, and an enzyme capable of hydrolyzing starch is provided.

Under “raw material”, a material is understood that has not yet been subjected to an extrusion process.

The raw material comprises inter alia starch. Starch is a polymeric carbohydrate (polysaccharide) consisting of numerous glucose units joined by glycosidic bonds. This polysaccharide is produced by most green plants for energy storage. It is the most common carbohydrate in human diets and is contained in large amounts in staple foods like potatoes, corn, rice, or wheat. Pure starch is a white, tasteless and odorless powder that is insoluble in cold water or alcohol. It consists of two types of molecules: the linear and helical amylose and the branched amylopectin. Depending on the plant, starch generally contains 20 to 25% amylose and 75 to 80% amylopectin by weight.

In a particular embodiment, the composition provided in step a) comprises from 50 to 90 wt. % starch, based on the total weight of the composition, preferably from 55 to 85 wt. %.

In a particular embodiment, the composition provided in step a) comprises from 50 to 60 wt. % starch, based on the total weight of the composition.

In a particular embodiment, the composition provided in step a) comprises from 75 to 85 wt. % starch, based on the total weight of the composition.

In a particular embodiment, the starch is corn starch, rice starch, potato starch, sorghum starch, oat starch, wheat starch, barley starch, or any mixture thereof. Preferably, the starch is corn starch, rice starch, potato starch, or any mixture thereof. More preferably, the starch is corn starch or rice starch.

The starch may be delivered by the addition of pure starch or by the addition of starch-containing compositions, such as flour. For example, the starch may be delivered by the addition of rice flour. The flour may be present in the raw material composition in an amount of from 60 to 80 wt. %, preferably 70 to 80 wt. %, based on the total weight of the composition. The raw material comprises inter alia water.

In a particular embodiment, the composition provided in step a) comprises from 7 to 35 wt. % water, based on the total weight of the composition, preferably from 10 to 26 wt. %.

In a particular embodiment, the composition provided in step a) comprises from 10 to 15 wt. % water, based on the total weight of the composition.

In a particular embodiment, the composition provided in step a) comprises from 21 to 26 wt. % water, based on the total weight of the composition.

The raw material comprises inter alia a flavor oil. Flavor oils are liquid at about 20° C. By “flavor oil”, it is meant here a flavouring ingredient or a mixture of flavouring ingredients, optionally further comprising a solvent or adjuvants, that is intended to be added to a composition (e.g. a consumer product) to impart, improve or modify its organoleptic properties, in particular its flavour and/or taste. Taste modulator as also encompassed in said definition. Flavouring ingredients are well known to a skilled person in the art and their nature does not warrant a detailed description here, which in any case would not be exhaustive, the skilled flavourist being able to select them on the basis of his general knowledge and according to the intended use or application and the organoleptic effect it is desired to achieve. Many of these flavouring ingredients are listed in reference texts such as in the book by S. Arctander, Perfume and Flavor Chemicals, 1969, Montclair, N.J., USA, or its more recent versions, or in other works of similar nature such as Fenaroli's Handbook of Flavor Ingredients, 1975, CRC Press or Synthetic Food Adjuncts, 1947, by M. B. Jacobs, can Nostrand Co., Inc. Suitable solvents and adjuvants are also well known in the art.

The phrase “flavor” includes not only flavors that impart or modify the smell of foods but include taste imparting or modifying ingredients. The latter do not necessarily have a taste or smell themselves but are capable of modifying the taste that other ingredients provides, for instance, salt enhancing ingredients, sweetness enhancing ingredients, umami enhancing ingredients, bitterness blocking ingredients and so on.

In a particular embodiment, the composition provided in step a) further comprises sweetening components. The sweetening component may be selected from the group consisting of sugar (e.g., but not limited to sucrose), a stevia component (such as but not limited to stevioside or rebaudioside A), sodium cyclamate, aspartame, sucralose, sodium saccharine, Acesulfam K, or mixtures thereof.

In a particular embodiment, the composition provided in step a) comprises from 5 to 35 wt. % flavor oil, based on the total weight of the composition, preferably from 10 to 30 wt. %.

In a particular embodiment, the composition provided in step a) comprises from 25 to 30 wt. % flavor oil, based on the total weight of the composition.

In a particular embodiment, the composition provided in step a) comprises 10 wt. % flavor oil, based on the total weight of the composition.

In a particular embodiment, the flavor oil is selected from the group consisting of orange oil, citrus oil, meat oil, limonene, or any mixture thereof. Preferably, the flavor oil is orange oil or limonene.

The raw material comprises inter alia an enzyme capable of hydrolyzing starch.

Enzymes capable of hydrolyzing starch are enzymes that are able to cleave the α-1,4 glycosidic and/or α-1,6 glycosidic bonds in starch.

In a particular embodiment, the enzyme capable of hydrolyzing starch is selected from the group consisting of α-amylase, β-amylase, glucoamylase, pullulanase, and any mixture thereof. Preferably, the enzyme capable of hydrolyzing starch is α-amylase. Alpha-amylase (α-amylase) is an enzyme that catalyzes the hydrolysis of the α-1,4 glycosidic bonds in a starch molecule.

In a particular embodiment, the α-amylase is a low-temperature α-amylase, a mid-temperature α-amylase, a high-temperature α-amylase, or a mixture thereof. A low-temperature α-amylase is an α-amylase that shows maximum enzyme activity in a temperature range of from 40 to 59° C. A mid-temperature α-amylase is an α-amylase that shows maximum enzyme activity in a temperature range of from 60 to 70° C. A high-temperature α-amylase is an α-amylase that shows maximum enzyme activity in a temperature range of from 80 to 110° C. Preferably, the α-amylase is a low-temperature or high-temperature α-amylase.

In a particular embodiment, two or more α-amylases are present in the composition provided in step a).

In a particular embodiment, two α-amylases are present in the composition provided in step a), wherein one of the two α-amylases is a high-temperature α-amylase and the other α-amylase is a low-temperature α-amylase.

In a particular embodiment, a mixture of enzymes capable of hydrolyzing starch is present in the composition provided in step a). Preferably, the mixture of enzymes comprises one or more α-amylases and a pullulanase. In a preferred embodiment, the mixture of enzymes comprises a low-temperature α-amylase, a high-temperature α-amylase, and a pullulanase.

In a particular embodiment, the composition provided in step a) comprises from 0.1 to 5 wt. % of the enzyme capable of hydrolyzing starch, based on the total weight of the composition, preferably from 0.5 to 3 wt. %, more preferably from 1 to 2 wt. %.

In a particular embodiment, the composition provided in step a) comprises from 0.1 to 5 wt. % of the enzyme capable of hydrolyzing starch, based on the total weight of the composition, preferably from 0.5 to 3.5 wt. %.

In a particular embodiment, the composition provided in step a) further comprises a lubricant. The lubricant may be present in the composition in an amount of from 0.5 to 3 wt. %, preferably 1 to 2 wt. %, based on the total weight of the composition. Preferably, the lubricant is a mixture of lecithin and medium-chain triacylglycerides, preferably at a ratio of 1:1.

In a particular embodiment, the composition provided in step a) is stored at a temperature of from 2 to 8° C., preferably at 4° C., for 12 to 24 hours, before method step b) is performed.

In method step b), the mixture provided in step a) is extruded to form an extruded particle comprising an encapsulated flavor oil, i.e. the mixture provided in step a) is subjected to an extrusion step.

Extrusion is a technique used in food processing well known to a skilled person. During extrusion, mixed ingredients are forced through an opening in a perforated plate or die designed to produce the required shape. The extruded food is then cut to a specific size by blades. The machine that forces the mixture of ingredients through the die is referred to as the extruder, and the extruded mixture of ingredients is also known as the extrudate. The extruder is typically a large, rotating screw tightly fitting within a stationary barrel, at the end of which is the die.

Extrusion enables mass production of foods via a continuous, efficient system that ensures uniformity of the final product. Food products manufactured using extrusion can have a high starch content.

In view of the presence of an enzyme capable of hydrolyzing starch in the raw material composition, the starch is hydrolyzed to a starch hydrolysate during the extrusion step (method step b). Therefore, the starch present in the raw material composition represents the substrate for the formation of a starch hydrolysate that is formed during the extrusion step. The in situ formed starch hydrolysate then acts as carrier material for the flavor oil, i.e. the starch hydrolysate that is formed in situ during the extrusion step from starch, encapsulates the flavor oil by acting as carrier material for the flavor oil. Encapsulated flavor oil means that the flavor oil is entrapped within the starch hydrolysate matrix.

Therefore, the method according to the invention allows the in situ production of a starch hydrolysate that can then act as carrier material for the encapsulation of the flavor oil within one extrusion step. Hence, the method according to the invention allows the simultaneous formation of a starch hydrolysate from starch and encapsulation of the flavor oil within a starch hydrolysate matrix.

Depending on the composition of the raw material composition and the extrusion parameters selected in method step b), more or less hydrolysis of the starch will occur, leading to starch hydrolysates of different DE-values. Therefore, the method according to the present invention provides high flexibility for the production of starch hydrolysates of various DE-values that can act as carrier materials for encapsulating flavor oil.

The DE-value (dextrose equivalent) is indicative for the degree of polymerization of a starch hydrolysate, i.e. the number of monosaccharide units in the starch hydrolysate. The DE-value is calculated as follows:

$$DE = \frac{R e d ucing sugar in product ( expressed as glucose )}{Total solids content of starch hydrolysate} \times 100$$

The higher the DE-value, the higher the level of monosaccharide (glucose) and short chain polymers. Glucose (dextrose) possesses a DE-value of 100; the DE-value of untreated (native) starch is approximately zero. Because a starch hydrolysate consists of a mixture of polymers of different lengths, the DE-value is an average value. The standard method for determining the DE-value is based on the Lane-Eynon titration method that is well known to a person skilled in the art.

In a particular embodiment, the starch is hydrolyzed to a starch hydrolysate having a DE-value of from 1 to 40 during extrusion step b). Preferably, the starch is hydrolyzed to a starch hydrolysate having a DE-value of from 3 to 30.

In a particular embodiment, the starch is hydrolyzed to a maltodextrin, i.e. to a starch hydrolysate having a DE-value of from 3 to 20. Preferably the maltodextrin has a DE-value of from 3 to 8, more preferably from 4 to 7.5.

In a particular embodiment, the starch is hydrolyzed to a maltodextrin, i.e. to a starch hydrolysate having a DE-value of from 7 to 13.

In a particular embodiment, the starch is hydrolyzed to a maltodextrin, i.e. to a starch hydrolysate having a DE-value of below 20, preferably of from 1 to 19, more preferably of from 5 to 19.

In a particular embodiment, the starch is hydrolyzed to a glucose syrup, i.e. to a starch hydrolysate having a DE-value of higher than 20. Preferably the glucose syrup has a DE-value of from 25 to 30. In a particular embodiment, extrusion step b) is performed with a twin-screw extruder.

In a particular embodiment, the raw material composition is fed to the extruder in step b) at a feed rate of from 0.2 to 2 kg/h, preferably of from 0.3 to 1.5 kg/h.

In a particular embodiment, the raw material composition is fed to the extruder in step b) at a feed rate of 1.5 kg/h.

In a particular embodiment, the raw material composition is fed to the extruder in step b) at a feed rate of from 0.35 to 0.45 kg/h.

In a particular embodiment, the screw speed of the extruder in step b) is from 50 to 120 rpm, preferably from 60 to 100 rmp.

In a particular embodiment, the extruder in extrusion step b) shows at least four different temperature zones. One temperature zone may have a temperature of from 20 to 60° C., another temperature zone may have a temperature of from 25 to 80° C., yet another temperature zone may have a temperature of from 30 to 80° C., yet another temperature zone may have a temperature of equal to or greater than 90° C. Preferably, each temperature zone has a different temperature. Preferably, the temperatures in the different temperature zones increase towards the extruder exit or die, respectively.

In a particular embodiment, the extruder in extrusion step b) shows from four to eight temperature zones. Preferably, each temperature zone has a different temperature. Preferably, the temperatures in the different temperature zones increase towards the extruder exit or die, respectively.

In a particular embodiment, the extruder in extrusion step b) shows four temperature zones. Preferably, the first temperature zone has a temperature of from 20 to 60° C., the second temperature zone has a temperature of from 25 to 80° C., the third temperature zone has a temperature of from 30 to 80° C., the fourth temperature zone has a temperature of equal to or greater than 90° C. Preferably, the temperatures in the four temperature zones increase towards the extruder exit or die, respectively.

In a particular embodiment, the extruder in extrusion step b) shows a temperature zone having a temperature that deactivates the enzyme capable of hydrolyzing starch, i.e. upon arriving in said temperature zone, the enzyme capable of hydrolyzing starch will not exert any enzymatic activity any more, which allows further process control. Preferably, said temperature zone has a temperature of from 120 to 150° C.

In a particular embodiment, during extrusion step b), a flavor oil retention of from 20 to 90% is achieved, preferably from 25 to 60%. The flavor oil retention is calculated based on the original flavor oil content in the raw material composition and the flavor oil content determined in the extruded particles after extrusion, i.e. flavor oil retention is calculated as follows: (flavor oil content determined in the extruded particles after extrusion/flavor oil content in the raw material composition)×100.

Hence, in a particular embodiment, the extruded particle formed in step b) comprises from to 90%, preferably from 25 to 60%, of the flavor oil amount that is present in the raw material composition in step a).

The method according to the invention enables good flavor oil retention, which likewise shows that the flavor oil can be effectively encapsulated by the hydrolyzed starch that is formed in situ during method step b).

In a particular embodiment, during extrusion step b), a flavor oil retention of higher than 25%, preferably higher than 30%, more preferably higher than 40%, yet more preferably higher than 50%, is achieved.

The oil content in the extruded particles can be determined e.g. by LF-NMR (Bruker Biospin GmbH) Hahn-Spin-Echo analysis.

In a particular embodiment, in step b), the extruder die is a die face pelletizer.

In a particular embodiment, the extruded particles are dried after extrusion step b). Extruded particles can be dried by spray drying, by oven drying, by tumbler drying, by tray drying or fluid bed drying. As the method according to the invention allows low water contents during extrusion step b), less energy may be required in a subsequent drying step to remove residual moisture.

In a particular embodiment, the extruded particles are spray-dried after extrusion step b).

Another aspect of the invention relates to an extruded particle obtained by the method according to the invention comprising a flavor oil that is encapsulated by hydrolyzed starch as carrier material. Thereby, the flavor oil is entrapped within the hydrolyzed starch matrix.

In a particular embodiment, the hydrolyzed starch encapsulating the flavor oil has a DE-value of from 1 to 30, preferably of from 3 to 30.

In a particular embodiment, the hydrolyzed starch encapsulating the flavor oil has a DE-value of below 20, preferably of from 1 to 19, more preferably of from 5 to 19.

In a particular embodiment, the extruded particle comprises hydrolyzed starch in an amount of from 50 to 90 wt. %, based on the total weight of the extruded particle, preferably of from 55 to 85 wt. %.

In a particular embodiment, the extruded particle does not comprise native starch, i.e. starch that has not been hydrolyzed.

In a particular embodiment, the extruded particle has a water content of from 7 to 35 wt. % water, based on the total weight of the extruded particle, preferably of from 10 to 26 wt. %.

In a particular embodiment, the flavor oil being encapsulated by the hydrolyzed starch is selected from the group consisting of orange oil, citrus oil, meat oil, limonene, or any mixture thereof. Preferably, the flavor oil is orange oil or limonene.

In a particular embodiment, the extruded particle is in pellet form.

In a particular embodiment, the extruded particle is dried, i.e. moisture has been removed via e.g. spray-drying or fluid bed drying.

In an alternative embodiment, the extruded particle has not been spray dried. As indicated above, the method according to the invention allows low water contents in the initial raw material composition and hence, less energy-intensive drying steps may be required.

In a particular embodiment, the extruded particles is dried, i.e. moisture has been removed by oven drying or fluid bed drying.

In a particular embodiment, the extruded particle has a water solubility of from 50 to 90%, preferably of from 60 to 80%. The solubility is calculated and expressed as the weight of soluble solids per 100 grams of sample on dry weight basis. Specific methods to determine the water solubility are known by a skilled person. High water solubility is advantageous for the use of the extruded particle in many consumer product applications, such as powder soft drinks.

In a particular embodiment, the extruded particle has a Tg-value (glass transition temperature) of from 5 to 60° C., preferably of from 40 to 50° C. Tg-values above room temperature (20-25° C.) are particularly useful, as they allow the storage of the extruded particle at room temperature without stability issues. A skilled person knows how the Tg-value can be determined, for example, a TA Instruments Differential Scanning Calorimeter Q2000 (TA Instruments, New Castle, DE) can be used.

In a particular embodiment, the extruded particle has an oil content of from 3 to 30 wt. %, based on the total weight of the extruded particle, preferably of from 4 to 14 wt. %.

In a particular embodiment, the extruded particle has an oil content of from 4 to 6 wt. %, based on the total weight of the extruded particle.

In a particular embodiment, the extruded particle has an oil content of from 6 to 14 wt. %, based on the total weight of the extruded particle.

Another aspect of the invention relates to a consumer product comprising the extruded particle according to the invention.

In a particular embodiment, the consumer product is a food, pet-food or feed product.

The particles of the invention are particularly advantageous for dry food products susceptible to rehydration such as instant drinks (PSD, chocolate, coffee), confectionary like chewing gum, instant noodles, or stock cubes.

The particles of the invention are particularly advantageous for a food product with a relatively high-water activity such as a ready to use meal, meat analogs, microwave food, pasta boxes.

The particles of the invention can be used in vegetarian meat analogues or meat replacers, vegetarian burger, sausages, patties, chicken-imitate nuggets, meat products (e.g. processed meat, poultry, beef, pork, ham, fresh sausage or raw meat preparations, spiced or marinated fresh meat or cured meat products, reformed meat or extended meat products making use of a combination of animal and vegetable protein in varying ratios, often being coextruded or a mix between textured vegetable protein and animal protein. Meat, for the purpose of the present invention, encompasses red meat, such as beef, pork, sheep, lamb, game and poultry, such as chicken, turkey, goose and duck. Preferably, the meat is selected from beef, poultry, or pork.

Nevertheless, the particles of the invention can also be of particular interest in the following examples of food and beverage products:
Baked goods (e.g. bread, dry biscuits, cakes, other baked goods),
Non-alcoholic beverages (e.g. carbonated soft drinks, bottled waters, sports/energy drinks, juice drinks, vegetable juices, vegetable juice preparations),
Alcoholic beverages (e.g. beer and malt beverages, spirituous beverages),
Instant beverages (e.g. instant vegetable drinks, powdered soft drinks, instant coffee and tea),
Cereal products (e.g. breakfast cereals, pre-cooked ready-made rice products, rice flour products, millet and sorghum products, raw or pre-cooked noodles and pasta products),
Milk products (e.g. fresh cheese, soft cheese, hard cheese, milk drinks, whey, butter, partially or wholly hydrolysed milk protein-containing products, fermented milk products, condensed milk and analogues),
Dairy based products (e.g. fruit or flavored yoghurt, ice cream, fruit ices)
Confectionary products (e.g. chewing gum, hard and soft candy)
Chocolate and compound coatings
Products based on fat and oil or emulsions thereof (e.g. mayonnaise, spreads, margarines, shortenings, remoulade, dressings, spice preparations),
Spiced, marinated or processed fish products (e.g. fish sausage, surimi),
Eggs or egg products (dried egg, egg white, egg yolk, custard),
Desserts (e.g. gelatins and puddings)
Products made of soya protein or other soya bean fractions (e.g. soya milk and products made therefrom, soya lecithin-containing preparations, fermented products such as tofu or tempeh or products manufactured therefrom, soya sauces),
Vegetable preparations (e.g. ketchup, sauces, processed and reconstituted vegetables, dried vegetables, deep frozen vegetables, pre-cooked vegetables, vegetables pickled in vinegar, vegetable concentrates or pastes, cooked vegetables, potato preparations),
Vegetarian meat replacer, vegetarian burger
Spices or spice preparations (e.g. mustard preparations, horseradish preparations), spice mixtures and, in particular seasonings which are used, for example, in the field of snacks.
Snack articles (e.g. baked or fried potato crisps or potato dough products, bread dough products, extrudates based on maize, rice or ground nuts),
Meat products (e.g. processed meat, poultry, beef, pork, ham, fresh sausage or raw meat preparations, spiced or marinated fresh meat or cured meat products, reformed meat),
Ready dishes (e.g. instant noodles, rice, pasta, pizza, tortillas, wraps) and soups and broths (e.g. stock, savory cube, dried soups, instant soups, pre-cooked soups, retorted soups), sauces (instant sauces, dried sauces, ready-made sauces, gravies, sweet sauces).

In a particular embodiment, the consumer product is selected from the group consisting of baked goods, instant beverages, cereal products, milk products, dairy-based products, products based on fat and oil or emulsions thereof, desserts, vegetable preparations, vegetarian meat replacer, spices and seasonings, snacks, meat products, ready dishes, soups and broths and sauces.

In a particular embodiment, the consumer product is selected from the group consisting of a meat- and/or fish-based food or analogue, a stock, a savory cube, a powder mix, a beef or pork based product, a seafood, surimi, instant noodles, rice, soups, sauces, ready-made meal, frozen or chilled pizza, pasta, potato flakes or fried, noodles, a potato/tortilla chip, a microwave popcorn, nuts, a bretzel, a rice cake, a rice cracker, fermented dairy analogue beverage, acidified dairy analogue beverage, non-fermented dairy analogue beverage, cheese or cheese analogue, yoghurt or yoghurt analogue, nutritional supplement, nutritional bar, cereal, ice cream, dairy-free ice cream, confectionary product, chewing gum, hard-boiled candy and powdered drinks.

In a particular embodiment, the consumer product is a food, pet-food or feed product and comprises between 0.01 and 10% by weight, preferably between 0.1 and 5% by weight, of the extruded particle according to the invention. Typically, the food, pet-food or feed product further comprises proteins notably vegetable proteins or animal proteins, and mixtures thereof. Advantageously the vegetable proteins are preferably selected among soy protein, corn, peas, canola, sunflowers, sorghum, rice, amaranth, potato, tapioca, arrowroot, chickpeas, lupins, canola, wheat, oats, rye, barley, and mixtures thereof.

The particles of the invention are particularly suitable for extruded and/or baked food, pet-food or feed products more particularly comprising animal and/or vegetable proteins. Typically, said extruded and/or baked food, pet-food or feed products may be selected among meat- and/or fish-based food or analogue and mixtures thereof (in other words, meat-based food and/or fish-based food or meat analogue or fish analogue and mixtures thereof); extruded and/or baked meat analogue or extruded and/or baked fish analogue are preferred. Non-limiting examples of extruded and/or baked food, pet-food or feed products are snack products or extruded vegetable proteins with the aim to texture the protein from which meat analogous (e.g. burgers) are prepared from. The powder composition can be added pre-extrusion or after extrusion to either, the non-extruded vegetable protein isolate/concentrate or to the textured vegetable protein from which a burger or nugget (etc.) is formed.

In a particular embodiment, the consumer product is a food product or a beverage. Preferably, the consumer product is a powder soft drink (PDS), tea, a tea bag, or coffee. More preferably, the consumer product is a powder soft drink (PDS).

### EXAMPLES

### Example 1: Preparation of Extruded Particles

Extruded particles were prepared on a co-rotating twin screw extruder (FMHE36-24, Fumake Co., Hunan, China). The batch size was 10 kg for each extrusion experiment. Five blends (blends 1 to 5) of corn starch, high-temperature α-amylase, orange oil, and water were prepared according to Table 1, and kept at 4° C. for 16 hours. Each blend was fed into the extruder by a loss-in-weight feeder with feed rate of 1.5 kg/h. The four barrels of the extruder were independently temperature controlled with set points of from 60° C. to 90° C. from feeding to exit zone. Barrel temperatures were kept constant during the extrusion process. The screw speed was kept constant at 100 rpm.

TABLE 1
Blends 1 to 5 of corn starch, α-amylase, orange oil, and water.

| | 1 | 2 | 3 | 4 | 5 |
|---|---|---|---|---|---|
| Ingredient | mass percentage (wt. %) | | | | |
| corn starch | 59 | 59 | 58.5 | 58 | 59.5 |
| α-amylase | 1 | 1 | 1.5 | 2 | 0.5 |
| | | | | | 20 |
| water | 10 | 10 | 15 | 15 | 15 |
| orange oil | 25 | 30 | 25 | 25 | 25 |

After extrusion, the extruded particles 1 to 5 were assessed in terms of their oil content and their DE-values (dextrose equivalents). The results are given in Table 2 below.

The oil content of the extruded particles was determined by LF-NMR (Bruker Biospin GmbH) Hahn-Spin-Echo analysis. The NMR operated at 23 MHz and was equipped with a 20 mm probe with an 8 ρs delay time to allow oil content measurements. The sample relaxation delay was set to 20 s and 4 scans were accumulated for noise reduction. Oil retention was calculated based on the original oil content of the blend and the measured oil content. Oil contents of extruded particles 1 to 5 and the respective oil retention (%) are given in Table 2.

The DE-values have been determined based on the Lane-Eynon titration method. An amount of sample (extruded particle) has been weighed such that after dilution the solution contained about 0.6% reducing sugars. The sample has then been transferred quantitatively to a 500 mL volumetric flash with hot water. The sample has then been allowed to cool down to room temperature. Then, the sample has been diluted with water up to the graduation marking, and mixed thoroughly. 25.0 mL of standardized mixed Fehling's Solution have been pipetted into a 200 mL Erlenmeyer flask and a few glass beads have been added. The sample was then added by means of a buret within 0.5 mL of the anticipated end point (determined by preliminary titration). The flask has then been immediately placed on the wire gauze of the titration assembly and a burner has been adjusted such that the boiling point was reached in approximately 2 minutes. Further 2 minutes of boiling of the mixture was conducted. During boiling, 2 drops of methylene blue indicator have been added, and the titration has been completed within 1 minute. The endpoint has been reached when the blue color disappeared. The measured DE-values of samples 1 to 5 are given in Table 2.

TABLE 2
DE-values, oil content, and oil retention
of extruded samples 1 to 5.

| | | Oil content | Oil retention |
|---|---|---|---|
| Sample | DE-value | (wt. %) | (%) |
| 1 | 6.3 | 11.1 | 44.4 |
| 2 | 4.0 | 13.7 | 45.7 |
| 3 | 6.8 | 12.6 | 50.4 |
| 4 | 7.2 | 13.1 | 52.4 |
| 5 | 3.0 | 6.3 | 25.2 |

As indicated by DE-values of between 3.0 and 7.2, corn starch has effectively been hydrolyzed to maltodextrin in all five blends during the extrusion process. At the same time, the orange oil was effectively encapsulated by the formed maltodextrin as indicated by good oil retention amounts of between 25.2 and 52.4%. This shows that in the described process hydrolyzation of starch and encapsulation of the orange oil occurred simultaneous, i.e. within one extrusion step. Further, a low water content of 10 wt. % or 15 wt. %, respectively, was sufficient in the sample blends for the starch to be effectively hydrolyzed during the extrusion process.

Samples that showed a higher amount of α-amylase, also showed a higher DE-value after extrusion. In this regard, sample 1 and 2, respectively, showed a higher DE-value than sample 5, but sample 3 showed a higher DE-value than sample 1 and 2, respectively. Likewise, sample 4 showed a higher DE-value than sample 3.

### Example 2: Preparation of Extruded Particles

Extruded particles were prepared on a co-rotating twin screw extruder with screw diameter of 12 mm (EuroLab, L/D 25, Thermo Scientific). The diameter of the die hole was 3 mm. The batch size was 2 kg for each extrusion experiment.

Four blends (blends 6 to 9) of rice starch, high-temperature α-amylase, limonene, lubricant (mixture of lecithin and medium-chain triacylglycerides at a ratio of 1:1), and water were prepared according to Table 3, and kept at 4° C. for 16 hours

Each blend was fed into the extruder by a loss-in-weight feeder with feed rate of 0.35-0.45 kg/h (blend 6: 0.35 kg/h; blend 7: 0.45 kg/h; blend 8: 0.35 kg/h; blend 9: 0.45 kg/h). The six extruder barrels were independently temperature controlled with set points of from 25° C. to 135° C. from feeding to exit zone. Barrel temperatures were kept the same during extrusion process. The screw speed was kept constant at 60 rpm.

TABLE 3
Blends 6 to 9 of rice starch, high-temperature
α-amylase, limonene, lubricant, and water.

| | | | |
|---|---|---|---|
| 6 | 7 | 8 | 9 |

| | |
|---|---|
| Ingredient | mass percentage (wt. %) |

| | | | | |
|---|---|---|---|---|
| rice starch | 79.8 | 79.5 | 79 | 84 |
| α-amylase | 1 | 1.5 | 1 | 1.5 |
| limonene | 10 | 10 | 10 | 10 |
| lubricant | 1 | 1 | 1 | 1 |
| water | 21 | 26 | 21 | 21 |

The DE-value, water solubility, Tg-value (glass transition temperature), and oil content of each extruded particle was determined. By means of the oil content, also the oil retention (%) could be calculated. The results are given in Table 4 below.

The DE-value of each sample has been determined by Lane-Eynon titration method as described in Example 1 above.

Water solubility was determined by making up aqueous solutions containing 10% of solids (dry basis). Duplicate samples were prepared for each sample. These solutions were loaded into a table top centrifuge (Cole Parmer Niles, IL) and spun at 6000 rpm for 10 minutes. The supernatant was discarded and the precipitates were transferred to an aluminum pan and dried in oven at 100° C. until constant weight. The solubility was calculated and expressed as the weight of soluble solids per 100 grams of sample on dry weight basis.

Glass Transition Temperature (Tg) measurements were conducted on a TA Instruments Differential Scanning Calorimeter Q2000 (TA Instruments, New Castle, DE). Small samples (˜10 mg) were sealed in hermetic Tzero pans. The program consisted of the following steps: equilibrate at −20° C. for 5 minutes, ramp to 100° C. at 10° C./min, cooling to −20° C., hold isothermal at −20° C. for 5 min and ramp to 100° C. at 10° C./min. The glass transition temperature was taken as the inflection point on the second heating ramp (rescan). Each sample was run in duplicate and the average was reported.

The oil content in the samples was determined by LF-NMR (Bruker Biospin GmbH) equipped with a 20 MHz probe assembly (H20-18-25AM1). Calibration was made with neat oils. Extruded particles were analyzed in triplicates and the average was reported.

TABLE 4
DE-value, water solubility, Tg-value, oil content,
and oil retention of extruded samples 6 to 9

| | | Water | Tg- | Oil | Oil |
|---|---|---|---|---|---|
| | | solubility | value | content | retention |
| Sample | DE-value | (%) | (° C.) | (wt. %) | (%) |
| 6 | 27.4 | 73.6 | 40.9 | 4.9 | 49 |
| 7 | 28.2 | 66.2 | 7.6 | 6.0 | 60 |
| 8 | 28.0 | 70.1 | 46.0 | 5.0 | 50 |
| 9 | 30.0 | 76.1 | 43.2 | 5.3 | 53 |

As indicated by DE-values of between 27.4 and 30, rice starch has effectively been hydrolyzed in all four blends during the extrusion process. At the same time, limonene was effectively encapsulated by the hydrolyzed starch material as indicated by good oil retention amounts of between 49 and 60%. This shows that in the described process hydrolyzation of starch and encapsulation of limonene occurred simultaneous, i.e. within one extrusion step. Further, a low water content of 21 wt. % or 26 wt. %, respectively, was sufficient in the sample blends for the starch to be effectively hydrolyzed during the extrusion process.

Samples 6, 8, and 9, wherein only a water amount of 21 wt. % was present, showed a high Tg-value, which ensures physical stability of the extruded particles during storage at room temperature. Therefore, a low water content was sufficient to hydrolyze starch during the extrusion step and to produce shelf-stable extruded particles.

### Example 3: Preparation of Extruded Particles

Extruded particles were prepared on a co-rotating twin screw extruder with screw diameter of 12 mm (EuroLab, L/D 25, Thermo Scientific). The diameter of the die hole was 3 mm. The batch size was 2 kg for each extrusion experiment.

Two blends (blends 10 and 11) of rice starch, high-temperature α-amylase, low-temperature α-amylase, pullulanase, limonene, lubricant (mixture of lecithin and medium-chain triacylglycerides at a ratio of 1:1), and water were prepared according to Table 5, and kept at 4° C. for 16 hours.

Each blend was fed into the extruder by a loss-in-weight feeder with feed rate of 0.5-0.6 kg/h (blend 10: 0.5 kg/h; blend 11: 0.6 kg/h). The six extruder barrels were independently temperature controlled with set points of from 25° C. to 110° C. from feeding to exit zone. Barrel temperatures were kept the same during extrusion process. The screw speed was kept constant at 180 rpm (blend 10) and 250 rpm (blend 11), respectively.

TABLE 5
Blends 10 and 11 of rice starch, high-temperature
α-amylase, low-temperature α-amylase, pullulanase,
limonene, lubricant, and water.

| | |
|---|---|
| 10 | 11 |

| | |
|---|---|
| | mass |
| | percentage |
| Ingredient | (wt. %) |

| | | |
|---|---|---|
| rice starch | 70.5 | 69.5 |
| α-amylase | 1 | 1 |
| (high-temp.) | | |
| α-amylase | 1.5 | 1.5 |
| (low-temp.) | | |
| pullulanase | 1 | 1 |
| limonene | 10 | 10 |
| lubricant | 2 | 1 |
| water | 14 | 15 |

The DE-value, water solubility, Tg-value (glass transition temperature), and oil content of each extruded particle was determined as described in Example 2 above. By means of the oil content, also the oil retention (%) could be calculated. The results are given in Table 6 below.

TABLE 6
DE-value, water solubility, Tg-value, oil content, and
oil retention of extruded samples 10 and 11. For reference,
also the values for rice starch are given.

| | | Water | Tg- | Oil | Oil |
|---|---|---|---|---|---|
| | | solubility | value | content | retention |
| Sample | DE-value | (%) | (° C.) | (wt. %) | (%) |
| Rice starch | 0 | 6.2 | n.a. | n.a. | n.a. |
| 10 | 7.2 | 50 | 40 | 6.2 | 62 |
| 11 | 10.5 | 60 | 31 | 6.9 | 69 |

As indicated by DE-values of 7.2 and 10.5, rice starch has effectively been hydrolyzed in the two blends during the extrusion process. At the same time, limonene was effectively encapsulated by the hydrolyzed starch material as indicated by good oil retention amounts of 62 and 69%. This shows that in the described process hydrolyzation of starch and encapsulation of limonene occurred simultaneous, i.e. within one extrusion step. Further, a low water content of 14 wt. % and 15 wt. %, respectively, was sufficient in the sample blends for the starch to be effectively hydrolyzed during the extrusion process.

Samples 10 and 11 showed Tg-values of 40° C. and 31° C., respectively, which ensures physical stability of the extruded particles during storage at room temperature. Therefore, the extrusion process lead to shelf-stable extruded particles without the need of further drying steps such as e.g. spray-drying.

### Example 4: Preparation of Extruded Particles

Extruded particles were prepared on a co-rotating twin screw extruder with screw diameter of 12 mm (EuroLab, L/D 25, Thermo Scientific). The diameter of the die hole was 3 mm. The batch size was 2 kg for each extrusion experiment.

Four blends (blends 12 to 15) of rice flour; one or more of: high-temperature α-amylase, low-temperature α-amylase, and pullulanase; limonene; lubricant (mixture of lecithin and medium-chain triacylglycerides at a ratio of 1:1); and water were prepared according to Table 7, and kept at 4° C. for 16 hours.

Each blend was fed into the extruder by a loss-in-weight feeder with feed rate of 0.6 kg/h. The six extruder barrels were independently temperature controlled with set points of from 20° C. to 110° C. from feeding to exit zone. Barrel temperatures were kept the same during extrusion process. The screw speed was kept constant at 250 rpm.

TABLE 7
Blends 12 and 15 of rice flour; one or more of: high-temperature
a-amylase, low-temperature a-amylase, and pullulanase;
limonene; lubricant (mixture of lecithin and medium-chain
triacylglycerides at a ratio of 1:1); and water.

| | | | |
|---|---|---|---|
| 12 | 13 | 14 | 15 |

| | |
|---|---|
| Ingredient | mass percentage (wt. %) |

| | | | | |
|---|---|---|---|---|
| rice flour | 74.5 | 75.5 | 74.5 | 75.5 |
| α-amylase | 1 | 3.5 | 2 | 1 |
| (high-temp.) | | | | |
| α-amylase | 1.5 | 0 | 1.5 | 2.5 |
| (low-temp.) | | | | |
| pullulanase | 1 | 0 | 0 | 0 |
| limonene | 10 | 10 | 10 | 10 |
| lubricant | 2 | 1 | 2 | 1 |
| water | 10 | 10 | 10 | 10 |

The DE-value, water solubility, Tg-value (glass transition temperature), and oil content of each extruded particle was determined as described in Example 2 above. By means of the oil content, also the oil retention (%) could be calculated. The results are given in Table 8 below.

TABLE 8
DE-value, water solubility, Tg-value, oil content, and
oil retention of extruded samples 12 to 15. For reference,
also the values for rice flour are given.

| | | Water | Tg- | Oil | Oil |
|---|---|---|---|---|---|
| | | solubility | value | content | retention |
| Sample | DE-value | (%) | (° C.) | (wt. %) | (%) |
| Rice flour | 0.3 | 2 | n.a. | n.a. | n.a. |
| 12 | 11.5 | 63 | 34 | 6.6 | 66 |
| 13 | 8.1 | 54 | n.a. | 6.7 | 67 |
| 14 | 10.5 | 50 | n.a. | 7.7 | 77 |
| 15 | 9.9 | 45 | n.a. | 8.0 | 80 |

As indicated by DE-values between 8.1 and 11.5, rice starch in rice flour has effectively been hydrolyzed in the four blends during the extrusion process. At the same time, limonene was effectively encapsulated by the hydrolyzed starch material as indicated by good oil retention amounts of between 66 and 80%. This shows that in the described process hydrolyzation of starch and encapsulation of limonene occurred simultaneous, i.e. within one extrusion step. Further, a low water content of 10 wt. % was sufficient in the sample blends for the starch to be effectively hydrolyzed during the extrusion process.

Sample 12 showed Tg-values of 34° C., which ensures physical stability of the extruded particles during storage at room temperature. Moreover, no cracking of the prepared samples was observed during storage at room temperature.

1. A method for producing an extruded particle comprising an encapsulated flavor oil, comprising the steps of:
a. providing a raw material composition comprising starch, water, flavor oil, and an enzyme capable of hydrolyzing starch; and
b. extruding the mixture provided in step a) to form an extruded particle comprising an encapsulated flavor oil.

2. The method according to claim 1, wherein during step b), the starch is hydrolyzed to a starch hydrolysate having a DE-value of from 1 to 40.

3. The method according to claim 1, wherein the composition provided in step a) comprises from 50 to 90 wt. % starch, based on the total weight of the composition.

4. The method according to claim 1, wherein the starch is corn starch, rice starch, potato starch, or any mixture thereof.

5. The method according to claim 1, wherein the composition provided in step a) comprises from 7 to 35 wt. % water, based on the total weight of the composition.

6. The method according to claim 1, wherein the composition provided in step a) comprises from 5 to 35 wt. % flavor oil, based on the total weight of the composition.

7. The method according to claim 1, wherein the composition provided in step a) comprises from 0.1 to 5 wt. % of the enzyme capable of hydrolyzing starch, based on the total weight of the composition.

8. The method according to claim 1, wherein the enzyme capable of hydrolyzing starch is selected from the group consisting of α-amylase, β-amylase, glucoamylase, pullulanase, and any mixture thereof.

9. The method according to claim 8, wherein the enzyme capable of hydrolyzing starch is a α-amylase.

10. The method according to claim 1, wherein the composition provided in step a) is stored at a temperature of from 2 to 8° C., for 12 to 24 hours, before extrusion step b) is performed.

11. The method according to claim 1, wherein the extruder in extrusion step b) shows at least four different temperature zones.

12. The method according to claim 1, wherein the screw speed of the extruder in step b) is from 50 to 120 rpm.

13. The method according to claim 1, wherein the flavor oil is selected from the group consisting of orange oil, citrus oil, meat oil, limonene, and any mixture thereof.

14. The method according to claim 1, wherein the extruded particle formed in step b) comprises from 20 to 90% of the flavor oil that is present in the raw material composition in step a).

15. An extruded particle obtained by the method according to claim 1, comprising a flavor oil that is encapsulated by hydrolyzed starch as carrier material.

16. The method according to claim 1, wherein during step b), the starch is hydrolyzed to a starch hydrolysate having a DE-value of from 3 to 30.

17. The method according to claim 1, wherein the composition provided in step a) comprises from 55 to 85 wt. % starch, based on the total weight of the composition.

18. The method according to claim 1, wherein the composition provided in step a) comprises from 10 to 26 wt. % water, based on the total weight of the composition.

19. The method according to claim 1, wherein the composition provided in step a) comprises from 10 to 30 wt. % flavor oil, based on the total weight of the composition.

20. The method according to claim 1, wherein the composition provided in step a) comprises from 0.5 to 3 wt. % of the enzyme capable of hydrolyzing starch, based on the total weight of the composition.
